(19) United States
(12) Patent Application Publication
(10) Pub. No.: US 2024/0179576 A1
(43) Pub. Date: May 30, 2024

(54) SUBSCRIBER GROUP QUALITY OF SERVICE ADJUSTMENTS

(71) Applicant: DISH WIRELESS L.L.C., ENGLEWOOD, CO (US)

(72) Inventors: Kazi Bashir, Lewisville, TX (US); Mehdi Alasti, Reston, VA (US); Siddhartha Chenumolu, Broadlands, VA (US)

(21) Appl. No.: 18/070,312

(22) Filed: Nov. 28, 2022

(51) Int. Cl. H04W 28/24; H04W 8/18; H04W 24/08; H04W 28/02

(52) U.S. Cl. CPC H04W 28/24; H04W 8/186; H04W 24/08; H04W 28/0268; H04W 28/0289

(57) ABSTRACT

Embodiments are directed towards systems a system that, in situations of detected heavy network congestion, by upgrading the respective quality of service (QoS) (e.g., aggregate maximum bit rate (AMBR)) provided to the subscriber that requested the increase (e.g., who paid for premium service) by a first amount in response to the request while also downgrading respective QoS attributes (AMBRs) provided to the other subscribers in the group by a collective total of a second amount. The second amount may be equal to the firs amount such that the first subscriber to which the QoS attribute upgrade (e.g., AMBR increase) was provided uses a larger portion of the total maximum bandwidth capacity than at least one of the other subscribers operating at the degraded respective QoS attribute (e.g., decreased AMBR).

### BRIEF SUMMARY

Each subscriber in a group of subscribers on a cellular telecommunication network may be provided an individual Quality of Service (QoS) profile with attributes including device aggregate maximum bit rate (user equipment-AMBR (UE-AMBR)) and session aggregate maximum bit rate (protocol data unit-AMBR (PDU-AMBR)). However, even if a certain subscriber in the group has higher QoS attributes (e.g., PDU-AMBR) than the others, since some of the QoS attributes (e.g., the PDU-AMBR) are not guaranteed and packets of different subscribers may have the same priority level, under heavy network congestion, the subscribers may still receive the same treatment regarding any available resources (e.g., bandwidth) and thus receive the same treatment (e.g., bit rate). As disclosed herein, this problem is solved, in such situations of heavy network congestion, by upgrading the respective QoS attributes (e.g., PDU-AMBR) provided to the subscriber that requested the upgrade (e.g., that paid for premium service) by a first amount in response to the request while also downgrading respective QoS attributes (e.g., PDU-AMBRs) provided to the other subscribers in the group by a collective total of a second amount which may be equal to the firs amount. Hereafter, AMBR includes one or more of UE-AMBR, PDU-AMBR and network slice based AMBR (SMBR).

In an example embodiment, a subscriber may transmit a quality of QoS request for its AMBR to be increased by a first amount (e.g., when paying for upgraded service), such as through an application programming interface (API) via a fifth generation (5G) Network Exposure Function (NEF). The 5G network data analytics function (NWDAF) detects whether an increased level of current network congestion exists affecting a respective portion of bandwidth capacity currently available to each subscriber of the group of subscribers. If such an increased level of current network congestion exists as detected by the NWDAF, then system causes the NWDAF to request that the Policy Control Function (PCF) to increase the respective AMBR provided to the particular subscriber by the first amount while also decreasing respective AMBRs provided to other subscribers of the group of subscribers by a collective total of a second amount. This decreasing of the respective AMBRs provided to other subscribers of the group of subscribers by the second amount (which may be equal to the first amount) then provides additional bandwidth for use by the subscriber that paid for premium service, thus providing the premium bit rate experience for that subscriber.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a system for subscriber group QoS adjustments in accordance with embodiments described herein.

FIG. 2 illustrates example respective aggregate maximum bit rates (AMBRs) for each subscriber of a plurality of subscribers prior to adjustment in accordance with embodiments described herein.

FIG. 3 illustrates example respective aggregate maximum bit rates (AMBRs) for each subscriber of a plurality of subscribers after adjustment in accordance with embodiments described herein.

FIG. 4 illustrates a logical flow diagram showing one embodiment of a process for subscriber group QoS adjustments in accordance with embodiments described herein.

FIG. 5 illustrates a logical flow diagram showing one embodiment of a process adjusting respective QoS attributes (e.g., AMBRs), useful in the process of FIG. 4, in accordance with embodiments described herein.

FIG. 6 illustrates a logical flow diagram showing one embodiment of a process for subscriber QoS adjustments involving prioritizing each subscriber with respect to each other based on one or more QoS requests in accordance with embodiments described herein.

FIG. 7 shows a system diagram that describes an example implementation of an underlying computing system for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

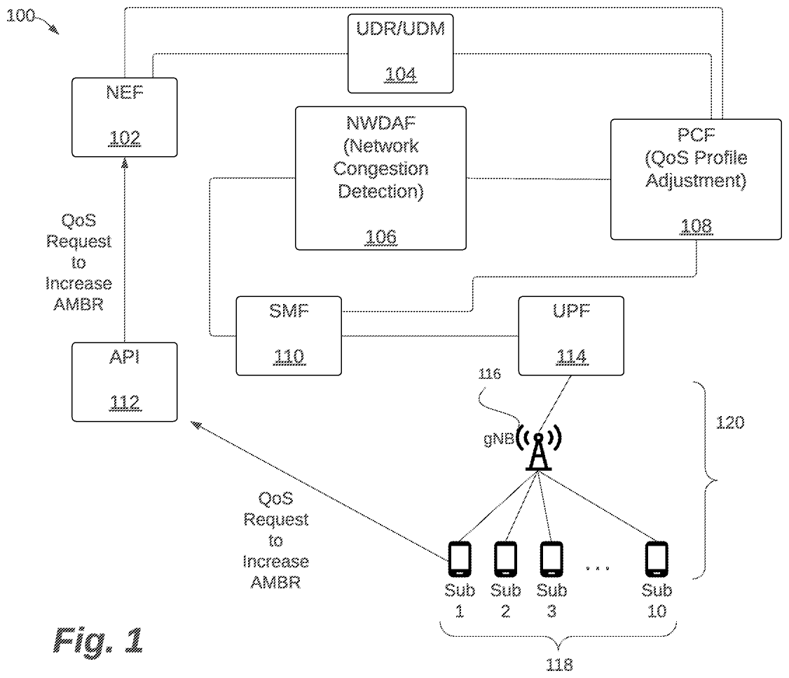

FIG. 1 illustrates a system 100 for subscriber group QoS adjustments in accordance with embodiments described herein.

A group of subscribers 118 of a cellular telecommunication network, such as the 5G communications network shown as part of system 100 in FIG. 1, may use various user equipment (UE). The UE may include devices such as cellular telephones or other Internet-of-Things (IoT) devices. Such UE may use 5G wireless cellular telecommunication technology defined by standards set by 3GPP and International Telecommunications Union (ITU) to get data connectivity between applications on the UE and Data Networks (DNs), such as the Internet or private corporate or enterprise networks. Almost all applications running on the UE, including voice, require such data connectivity. A Protocol Data Unit (PDU) session provides connectivity between applications on a UE and a DN. PDU sessions 120 represent the PDU sessions of the group of subscribers 118. The UE receives services through a PDU session, which is a logical connection between the UE and DN. PDU sessions 120 can provide different types of broadband services corresponding to the nature of the PDU(s) carried over the PDU session. In various embodiments, a PDU session may be associated with a single DN and with a single slice identified by Single-Network Slice Selection Assistance Information (S-NSSAI).

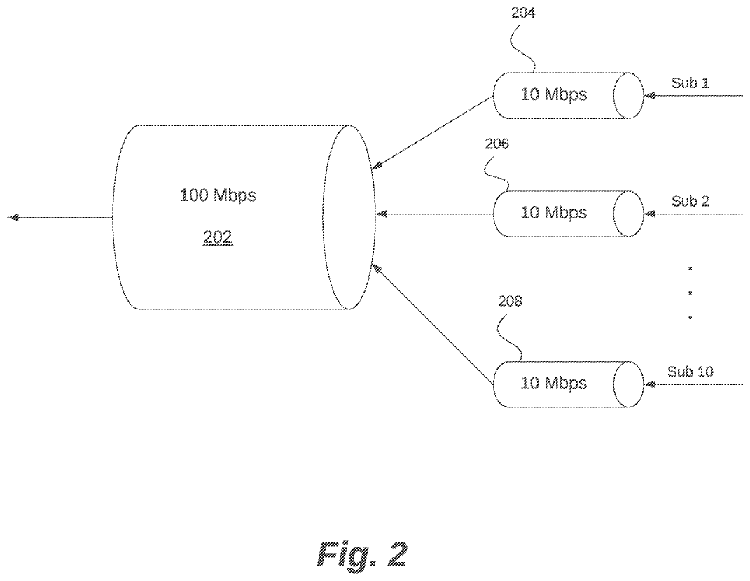

The UPF 114 is one of the network functions (NFs) of a 5G Core (5GC) network, such as that shown in FIG. 1. The UPF 114 is responsible for packet routing and forwarding, packet inspection, QoS handling, and interconnecting external PDU sessions 120 with the DN. Although one UPF 114 is shown in the present example, additional UPFs may be utilized in various other embodiments. UPF 114 is a virtual network function responsible for PDU sessions 120 between the UEs of the group of subscribers 118 and the DN by anchoring the PDU sessions 120 of various UEs of the group of subscribers 118 on the individual UPF 114. The SMF 110 is also one of the NFs of the 5GC and is primarily responsible for interacting with the decoupled data plane, creating, updating and removing PDU sessions, selecting particular UPFs on which to anchor PDU sessions when new UEs of the group of subscribers 118 appear on the network and managing session context with the UPF 114. The system 100 may include a 5G New Radio (5G NR) radio access network (RAN) that comprises of a set of radio base stations (each known as a Next Generation Node B (gNB), such as gNB 116, connected to the UEs of subscribers 118 and to the 5G core (5GC) via various 5G NR network functions shown in FIG. 2.

Bit rate limiting of non-guaranteed bit rate (non-GBR) network traffic may be implemented as a QoS feature according to 3GPP specifications in system 100. For example, at UPF 114, a particular PDU session of PDU sessions 120 may be provided a session aggregate maximum bit rate (AMBR). At gNB 116, a UE based AMBR may be implemented. Also in some embodiments, at gNB 116, a network slice based AMBR (SMBR) may be implemented. As an example of a particular PDU session being provided a specific AMBR, subscriber 1 may be provided an AMBR of 10 Mbps for Internet traffic. Although a 10 Mbps bit rate is not guaranteed, the UPF 114 would make its best effort to provide a 10 Mbps bit rate for the UE's PDU session of subscriber 1. However, if there is significant network congestion at the UPF 114, a 10 Mbps bit rate for the UE's PDU session may not be able to be achieved. It is desirable, though, to be able to provide a premium bit rate experience for certain priority subscribers, such as those that may pay for a higher AMBR as compared to other subscribers.

Thus, in an example embodiment, the subscriber (e.g., subscriber 1) may transmit a quality of service (QoS) request for its AMBR to be increased by a first amount (e.g., when paying for upgraded service), such as through an application programming interface (API) 112 via a 5G Network Exposure Function (NEF) 102. The NEF 102 facilitates secure and robust access to the exposed network services and capabilities of the 5G network of system 100. The NEF 102 may communicate directly with the Policy and Control Function (PCF) 108 to upgrade the subscriber's QoS profile, or it can go through the Unified Data Repository/Unified Data Management (UDR/UDM) 104 to upgrade the subscriber's QoS profile. The UDR is a unified database for storing application, subscription, authentication, service authorization, policy data, session binding and application state information. The UDM is responsible for generating credentials used during authentication, authorizing access based on user subscription, which it retrieves from the User Data Repository (UDR) and sends to the other network functions. In particular, the NEF 102 communicates with the PCF 108 directly or indirectly through the UDR/UDM 104 to indicate to the PCF 108 to upgrade the subscriber's QoS attribute (e.g., the QoS attribute of subscriber 1). The PCF 108 sends the QoS attributes to SMF 110.I 5G network data analytics function (NWDAF) 106 detects whether an increased level of current network congestion exists affecting a respective portion of bandwidth capacity currently available to each subscriber of the group of subscribers 118. If such an increased level of current network congestion exists as detected by the NWDAF 106, then the NWDAF 106 requests the Policy Control Function (PCF) 108 increase the respective AMBR provided to the particular subscriber by the first amount while also decreasing respective AMBRs provided to other subscribers of the group of subscribers 118 by a collective total of a second amount. This decreasing of the respective AMBRs provided to other subscribers of the group of subscribers 118 by a collective total of a second amount (which may be equal to the first amount) then provides additional bandwidth for use by subscriber 1, thus providing the premium bit rate experience for subscriber 1. The AMBR may include UE-AMBR (uplink and downlink), PDU-AMBR (uplink and downlink) and/or network slice SMBR (uplink and downlink). Various lines of communication are shown between the various NFs of system 100, which are enabled, for example, by various 5G network interfaces. However, other lines of communication may also exist in addition to those shown via various 5G network interfaces. Also, other 5G NFs not shown in FIG. 1 may also be present.

FIG. 2 illustrates example respective aggregate maximum bit rates (AMBRs) for each subscriber of a plurality of subscribers prior to adjustment in accordance with embodiments described herein.

In the example shown, a group of subscribers consisting of ten example subscribers each have a 10 Mbps AMBR at a cellular telecommunication network node (e.g., a UPF or gNB). In particular, subscriber 1 has an AMBR 204 of 10 Mbps and subscriber 2 has an AMBR 206 of 10 Mbps. This is true for all the subscribers, including subscriber 10, which also has an AMBR 208 of 10 Mbps. The network node has a total maximum bandwidth capacity 202 of 100 Mbps. In the present example, the node is heavily congested with network traffic. For example, the increased level of current network congestion may utilize the total (or near the total) maximum bandwidth capacity 202 of the cellular telecommunication network available to the group of subscribers. This affects a respective portion of bandwidth capacity 202 currently available to each subscriber on the cellular telecommunication network node.

Conventionally, since the packets of different subscribers may have the same priority level, under such heavy network congestion, the subscribers may receive the same treatment regarding any available bandwidth. For example, in conventional systems, during such heavy network congestion, if subscriber 1 changes its profile (through API/NEF) for its AMBR 204 to be 19 Mbps, all the subscribers will still receive the same bit rate.

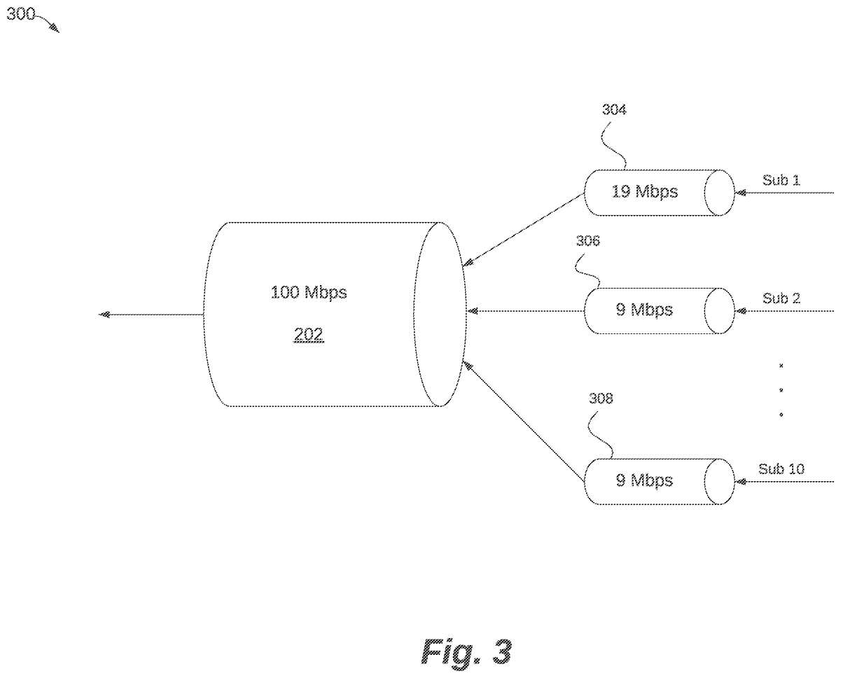

FIG. 3 illustrates example respective aggregate maximum bit rates (AMBRs) for each subscriber of a plurality of subscribers after adjustment in accordance with embodiments described herein.

In particular, in an example embodiment, the problem described above in which all the subscribers still receive the same bit rate is solved, in such situations of heavy network congestion, by increasing the respective AMBR 204 provided to subscriber 1 that requested the increase by a first amount in response to the request (e.g., changing subscriber 1 to have AMBR 304 of 19 Mbps), while also decreasing respective AMBRs provided to the other subscribers in the group by a collective total of a second amount. For example, the respective AMBRs provided to the other subscribers in the group may each be decreased by 1 Mbps, which in the present example results in a total decrease of 9 Mbps for the other subscribers in the group (which is also equal to the amount by which the AMBR for subscriber 1 was increased). As shown in FIG. 3, this results in changing subscriber 2 to have AMBR 306 of 9 Mbps. Except for subscriber 1, this decrease in AMBR would be made for all the other subscribers, including subscriber 10, whose AMBR would be changed to AMBR 308 of 9 Mbps. Thus, subscriber 1 then operates at a higher bit rate during network congestion than the other subscribers in the group that did not request (e.g., did not pay for) premium service.

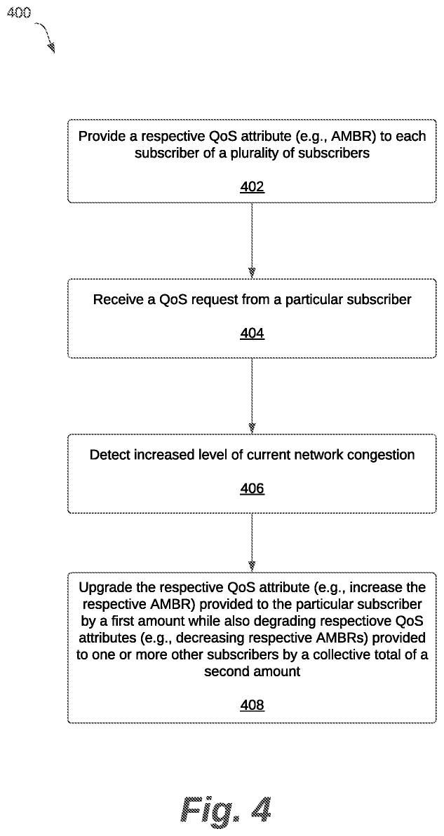

FIG. 4 illustrates a logical flow diagram showing one embodiment of a process 400 for subscriber group QoS adjustments in accordance with embodiments described herein.

At 402, the system 100 provides a respective QoS attribute (e.g., aggregate maximum bit rate (AMBR)) to each subscriber of a plurality of subscribers of a cellular telecommunication network. This may be performed in a manner such that a total of the respective QoS attributes (e.g., AMBRs) provided to the plurality of subscribers is equal to a total maximum bandwidth capacity of the cellular telecommunication network available to the plurality of subscribers at a particular network node.

At 404, the system 100 receives a quality of service (QoS) request from a particular subscriber of the plurality of subscribers for an upgraded QoS (e.g., increased AMBR). For example, this may include receiving the quality of service (QoS) request from the particular subscriber via an application programming interface (API) or a Network Exposure Function (NEF) of the cellular telecommunication network to adjust a QoS profile of the particular subscriber to upgrade the respective QoS (e.g., increase the respective AMBR) of the particular subscriber.

At 406, the system 100 detects, via a network data analytics function (NWDAF) of the cellular telecommunication network, an increased level of current network congestion at the node affecting a respective portion of bandwidth capacity currently available to each subscriber of the plurality of subscribers on the on the cellular telecommunication network.

At 408, the system 100, based on the detected increased level of current network congestion, upgrades the respective QoS attribute (e.g., increases the respective AMBR) provided to the particular subscriber by a first amount in response to the request while also degrading respective QoS attributes (e.g., decreases respective AMBRs) provided to one or more other subscribers of the plurality of subscribers by a collective total of a second amount. The first amount may be equal to the second amount such that during the detected increased level of current network congestion, the first subscriber uses a larger portion of the total maximum bandwidth capacity than at least one of the one or more other subscribers operating at the degraded respective QoS attribute (e.g., decreased respective AMBR) provided to the at least one other subscriber. In an example embodiment, a total of the upgraded respective QoS attribute (e.g., increased respective AMBR) for the particular subscriber and current respective QoS attributes (e.g., AMBRs) provided to the other subscribers of the plurality of subscribers after the decreasing equals the total maximum bandwidth capacity of the cellular telecommunication network available to the plurality of subscribers.

In an example embodiment, upgrading the respective QoS attributed (e.g., increasing the respective AMBR) provided to the particular subscriber may include requesting a Policy Control Function (PCF) of the cellular telecommunication network to adjust a QoS profile of the particular subscriber to upgrade the respective QoS attribute (e.g., increase the respective AMBR) provided to the particular subscriber. Also, downgrading respective QoS attributes (decreasing respective AMBRs) provided to one or more other subscribers may include requesting a Policy Control Function (PCF) of the cellular telecommunication network to adjust respective QoS profiles of the one or more other subscribers to downgrade respective QoS attributes (e.g., decrease respective AMBRs) provided to the one or more other subscribers.

Additionally, in various embodiments, the system 100 may validate the QoS request from the particular subscriber and upgrades the respective QoS attributes (e.g., increases the respective AMBR) provided to the particular subscriber by the first amount additionally based on the QoS request from the particular subscriber being validated.

Furthermore, in an example embodiment, the system 100 may detect, via the NWDAF of the cellular telecommunication network, a decreased level of current network congestion below the previously detected increased level of current network congestion. Based on the detected decreased level of current network congestion, the system 100 may downgrade the respective QoS attribute (e.g., decrease the respective AMBR) provided to the particular subscriber back to a QoS attribute (e.g., AMBR) before the increasing. This may be performed while also upgrading the respective QoS attributes (e.g., increasing respective AMBRs) provided to the one or more other subscribers such that a total of the downgraded the respective QoS attribute (e.g., decreased respective AMBR) for the particular subscriber and respective QoS attributes (e.g., respective AMBRs) provided to the other subscribers of the plurality of subscribers equals the total maximum bandwidth capacity of the cellular telecommunication network available to the plurality of subscribers.

In an example embodiment, the respective QoS attributes are aggregate maximum bit rate (AMBR) attributes; the QoS request is for an increased AMBR for the particular subscriber; the upgrading the respective QoS attribute includes increasing an AMBR provided to the particular subscriber; and the downgrading the respective QoS attributes includes decreasing the respective AMBRs provided to the one or more other subscribers of the plurality of subscribers by a collective total of the second amount. The respective AMBR may include at least one of: user equipment-AMBR (UE-AMBR), protocol data unit-AMBR (PDU-AMBR) and network slice based AMBR (SMBR). In an example embodiment, the UE-AMBR includes uplink UE-AMBR and downlink UE-AMBR; the PDU-AMBR includes uplink PDU-AMBR and downlink PDU-AMBR; and the SMBR includes uplink SMBR and downlink SMBR.

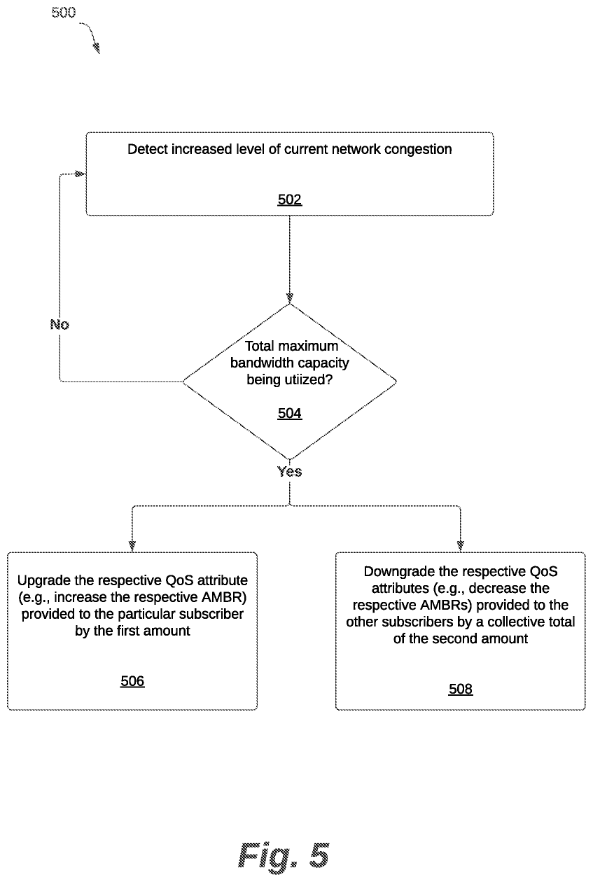

FIG. 5 illustrates a logical flow diagram showing one embodiment of a process 500 adjusting respective QoS attributes (e.g., respective AMBRs), useful in the process 400 of FIG. 4, in accordance with embodiments described herein.

At 502, the system 100 At 406, the system 100 detects, via a network data analytics function (NWDAF) of the cellular telecommunication network, an increased level of current network congestion affecting a respective portion of bandwidth capacity currently available to each subscriber of the plurality of subscribers on the on the cellular telecommunication network.

At 504, the system 100 determines whether the increased level of current network congestion utilizes the total maximum bandwidth capacity of the cellular telecommunication network available to the plurality of subscribers. If it is determined that the increased level of current network congestion utilizes the total maximum bandwidth capacity of the cellular telecommunication network available to the plurality of subscribers, then the process 500 proceeds to 506 and 508. If it is determined that the increased level of current network congestion does not utilize the total maximum bandwidth capacity of the cellular telecommunication network available to the plurality of subscribers, then the process 500 proceeds back to 502. Other bandwidth utilization thresholds may be used in the determination at 504 in various different embodiments.

At 506, the system 100 upgrades the respective QoS attribute (e.g., increases the respective AMBR) provided to the particular subscriber by the first amount.

At 508, the system 100 downgrades the respective QoS attributes (e.g., decreases respective AMBRs) provided to one or more other subscribers of the plurality of subscribers by a collective total of the second amount.

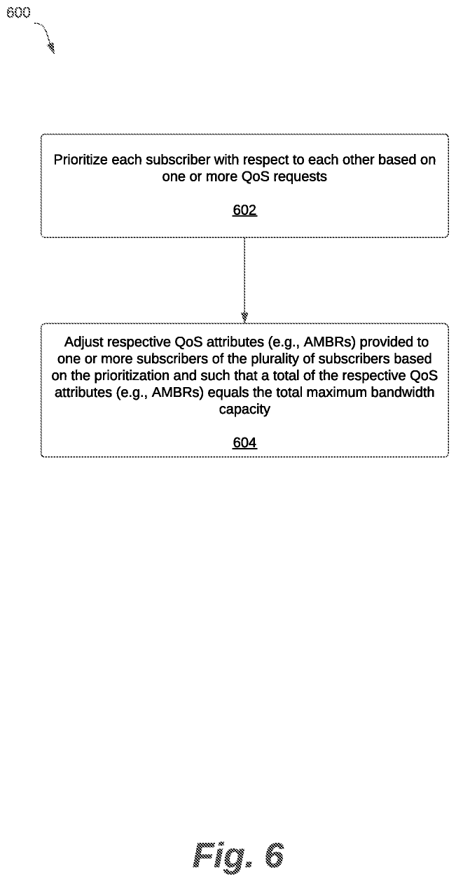

FIG. 6 illustrates a logical flow diagram showing one embodiment of a process 600 for subscriber QoS adjustments involving prioritizing each subscriber with respect to each other based on one or more QoS requests in accordance with embodiments described herein.

At 602, the system 100 prioritizes each subscriber of the plurality of subscribers with respect to each other based on one or more QoS requests to upgrade the respective QoS attributes (e.g., increase respective AMBRs).

At 604, the system 100 adjusts respective QoS attributes (e.g., AMBRs) provided to one or more subscribers of the plurality of subscribers based on the prioritization and the detected increased level of current network congestion. This may be performed such that a total of the respective QoS attributes (e.g., AMBRs) provided to the plurality of subscribers after the adjusting equals the total maximum bandwidth capacity of the cellular telecommunication network available to the plurality of subscribers.

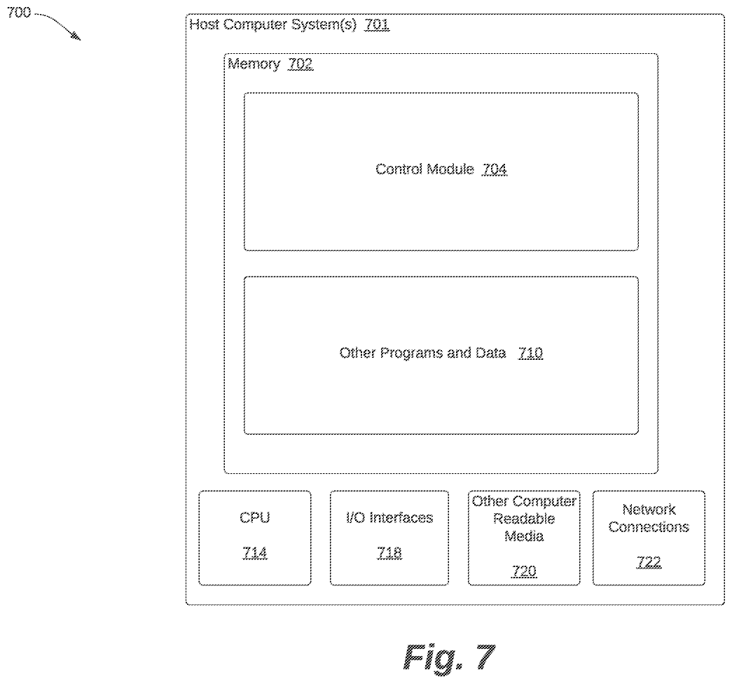

FIG. 7 shows a system diagram that describes an example implementation of an underlying computing system for implementing embodiments described herein.

The functionality described herein for subscriber group QoS adjustments can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 7 illustrates an example of underlying hardware on which such software and functionality may be hosted and/or implemented.

In particular, shown is example host computer system(s) 701. For example, such computer system(s) 701 may represent one or more of those in various data centers, base stations and cell sites shown and/or described herein that are, or that host or implement the functions of: routers, components, microservices, PODs, containers, nodes, node groups, control planes, clusters, virtual machines, NFs, and other aspects described herein for subscriber group QoS adjustments. In some embodiments, one or more special-purpose computing systems may be used to implement the functionality described herein. Accordingly, various embodiments described herein may be implemented in software, hardware, firmware, or in some combination thereof. Host computer system(s) 701 may include memory 702, one or more central processing units (CPUs) 714, I/O interfaces 718, other computer-readable media 720, and network connections 722.

Memory 702 may include one or more various types of non-volatile and/or volatile storage technologies. Examples of memory 702 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 702 may be utilized to store information, including computer-readable instructions that are utilized by CPU 714 to perform actions, including those of embodiments described herein.

Memory 702 may have stored thereon control module(s) 704. The control module(s) 704 may be configured to implement and/or perform some or all of the functions of the systems, components and modules described herein for subscriber group QoS adjustments. Memory 702 may also store other programs and data 710, which may include rules, databases, application programming interfaces (APIs), policy and charging rules and data, OSS data, BSS data, software containers, nodes, PODs, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 722 are configured to communicate with other computing devices to facilitate the functionality described herein. In various embodiments, the network connections 722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 518 may include location data interfaces, sensor data interfaces, interfaces, other data input or output interfaces, or the like. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a memory that stores computer instructions; and
a processor that executes the computer instructions to perform actions, the actions including:
providing a respective quality of service (QoS) attribute to each subscriber of a plurality of subscribers of a cellular telecommunication network such that a total of resources of the respective QoS attributes provided to the plurality of subscribers is equal to a total maximum bandwidth capacity of the cellular telecommunication network available to the plurality of subscribers at a network node;
receiving a quality of service (QoS) request from a particular subscriber of the plurality of subscribers for an upgraded QoS;
detecting, via a network data analytics function (NWDAF) of the cellular telecommunication network, an increased level of current network congestion affecting a respective portion of bandwidth capacity currently available to each subscriber of the plurality of subscribers on the on the cellular telecommunication network; and
based on the detected increased level of current network congestion, upgrading the respective QoS attribute provided to the particular subscriber by a first amount in response to the request while also downgrading respective QoS attributes provided to one or more other subscribers of the plurality of subscribers by a collective total of a second amount.

2. The system of claim 1 wherein the first amount is equal to the second amount such that during the detected increased level of current network congestion, the first subscriber uses a larger portion of the total maximum bandwidth capacity than at least one of the one or more other subscribers operating at the downgraded respective QoS attribute provided to the at least one other subscriber.

3. The system of claim 2 wherein a total of the upgraded respective QoS attribute for the particular subscriber and current respective QoS attributes provided to the other subscribers of the plurality of subscribers after the downgrading equals the total maximum bandwidth capacity of the cellular telecommunication network available to the plurality of subscribers.

4. The system of claim 1 wherein the upgrading the respective QoS attribute provided to the particular subscriber a first amount in response to the request while also downgrading respective QoS attributes provided to the one or more other subscribers includes:
determining whether the increased level of current network congestion utilizes the total maximum bandwidth capacity of the cellular telecommunication network available to the plurality of subscribers; and
based on determining that the increased level of current network congestion utilizes the total maximum bandwidth capacity of the cellular telecommunication network available to the plurality of subscribers:
upgrading the respective QoS attribute provided to the particular subscriber by the first amount; and
degrading respective QoS attributes provided to one or more other subscribers of the plurality of subscribers by a collective total of the second amount.

5. The system of claim 1 wherein the upgrading the respective QoS attribute provided to the particular subscriber a first amount in response to the request while also degrading respective QoS attributes provided to the one or more other subscribers includes:
validating the QoS request from the particular subscriber; and
upgrading the respective QoS attribute provided to the particular subscriber by the first amount based on the QoS request from the particular subscriber being validated.

6. The system of claim 1 wherein the actions further include:
prioritizing each subscriber of the plurality of subscribers with respect to each other based on one or more QoS requests to upgrade respective QoS attributes; and
adjusting respective QoS attributes provided to one or more subscribers of the plurality of subscribers based on the prioritization and the detected increased level of current network congestion, and such that a total of the respective QoS attributes provided to the plurality of subscribers after the adjusting equals the total maximum bandwidth capacity of the cellular telecommunication network available to the plurality of subscribers.

7. The system of claim 1 wherein the actions further include:
detecting, via the NWDAF of the cellular telecommunication network, a decreased level of current network congestion below the previously detected increased level of current network congestion; and
based on the detected decreased level of current network congestion, downgrading the respective QoS attribute provided to the particular subscriber back to a QoS attribute before the upgrading while also upgrading respective QoS attributes provided to the one or more other subscribers such that a total of the downgraded respective QoS attribute for the particular subscriber and respective QoS attributes provided to the other subscribers of the plurality of subscribers equals the total maximum bandwidth capacity of the cellular telecommunication network available to the plurality of subscribers.

8. The system of claim 1, wherein the increasing the respective QoS attribute provided to the particular subscriber includes:
requesting a Policy Control Function (PCF) of the cellular telecommunication network to adjust a QoS profile of the particular subscriber to upgrade the respective QoS attribute provided to the particular subscriber.

9. The system of claim 1, wherein the downgrading respective QoS attributes provided to one or more other subscribers includes:
requesting a Policy Control Function (PCF) of the cellular telecommunication network to adjust respective QoS profiles of the one or more other subscribers to degrade respective QoS attributes provided to the one or more other subscribers.

10. The system of claim 1, wherein the receiving the quality of service (QoS) request from the particular subscriber for an upgraded QoS attribute includes:
receiving the quality of service (QoS) request from the particular subscriber via an application programming interface (API) or a Network Exposure Function (NEF) of the cellular telecommunication network to adjust a QoS profile of the particular subscriber to upgrade the respective QoS attribute of the particular subscriber.

11. The system of claim 1 wherein:
the respective QoS attributes are aggregate maximum bit rate (AMBR) attributes;
the QoS request is for an increased AMBR for the particular subscriber;
the upgrading the respective QoS attribute includes increasing an AMBR provided to the particular subscriber; and
the downgrading the respective QoS attributes includes decreasing the respective AMBRs provided to the one or more other subscribers of the plurality of subscribers by a collective total of the second amount.

12. A method, comprising:
providing a respective aggregate maximum bit rate (AMBR) to each subscriber of a plurality of subscribers of a cellular telecommunication network such that a total of the respective AMBRs provided to the plurality of subscribers is equal to a total maximum bandwidth capacity of the cellular telecommunication network available to the plurality of subscribers at a network node, wherein the respective AMBR includes at least one of: user equipment-AMBR (UE-AMBR), protocol data unit-AMBR (PDU-AMBR) and network slice based AMBR (SMBR);
receiving a quality of service (QoS) request from a particular subscriber of the plurality of subscribers for an increased AMBR;
detecting, via a network data analytics function (NWDAF) of the cellular telecommunication network, an increased level of current network congestion affecting a respective portion of bandwidth capacity currently available to each subscriber of the plurality of subscribers on the on the cellular telecommunication network; and
based on the detected increased level of current network congestion, increasing the respective AMBR provided to the particular subscriber by a first amount in response to the request while also decreasing respective AMBRs provided to one or more other subscribers of the plurality of subscribers by a collective total of a second amount.

13. The method of claim 12 wherein the first amount is equal to the second amount such that during the detected increased level of current network congestion, the first subscriber uses a larger portion of the total maximum bandwidth capacity than at least one of the one or more other subscribers operating at the decreased respective AMBR provided to the at least one other subscriber.

14. The method of claim 13 wherein a total of the increased respective AMBR for the particular subscriber and current respective AMBRs provided to the other subscribers of the plurality of subscribers after the decreasing equals the total maximum bandwidth capacity of the cellular telecommunication network available to the plurality of subscribers.

15. The method of claim 12 wherein the increasing the respective AMBR provided to the particular subscriber a first amount in response to the request while also decreasing respective AMBRs provided to the one or more other subscribers includes:
determining whether the increased level of current network congestion utilizes the total maximum bandwidth capacity of the cellular telecommunication network available to the plurality of subscribers; and
based on determining that the increased level of current network congestion utilizes the total maximum bandwidth capacity of the cellular telecommunication network available to the plurality of subscribers:
increasing the respective AMBR provided to the particular subscriber by the first amount; and
decreasing respective AMBRs provided to one or more other subscribers of the plurality of subscribers by a collective total of the second amount.

16. The method of claim 12 wherein the increasing the respective AMBR provided to the particular subscriber a first amount in response to the request while also decreasing respective AMBRs provided to the one or more other subscribers includes:
validating the QoS request from the particular subscriber; and
increasing the respective AMBR provided to the particular subscriber by the first amount based on the QoS request from the particular subscriber being validated.

17. A non-transitory computer-readable storage medium having computer-executable instructions stored thereon that, when executed by at least one computer processor, cause actions to be performed including:
providing a respective aggregate maximum bit rate (AMBR) to each subscriber of a plurality of subscribers of a cellular telecommunication network such that a total of the respective AMBRs provided to the plurality of subscribers is equal to a total maximum bandwidth capacity of the cellular telecommunication network available to the plurality of subscribers at a network node, wherein the respective AMBR includes at least one of: user equipment-AMBR (UE-AMBR), protocol data unit-AMBR (PDU-AMBR) and network slice based AMBR (SMBR);
receiving a quality of service (QoS) request from a particular subscriber of the plurality of subscribers for an increased AMBR;
detecting, via a network data analytics function (NWDAF) of the cellular telecommunication network, an increased level of current network congestion affecting a respective portion of bandwidth capacity currently available to each subscriber of the plurality of subscribers on the on the cellular telecommunication network; and
based on the detected increased level of current network congestion, increasing the respective AMBR provided to the particular subscriber by a first amount in response to the request while also decreasing respective AMBRs provided to one or more other subscribers of the plurality of subscribers by a collective total of a second amount.

18. The non-transitory computer-readable storage medium of claim 17 wherein the first amount is equal to the second amount such that during the detected increased level of current network congestion, the first subscriber uses a larger portion of the total maximum bandwidth capacity than at least one of the one or more other subscribers operating at the decreased respective AMBR provided to the at least one other subscriber.

19. The non-transitory computer-readable storage medium of claim 18 wherein a total of the increased respective AMBR for the particular subscriber and current respective AMBRs provided to the other subscribers of the plurality of subscribers after the decreasing equals the total maximum bandwidth capacity of the cellular telecommunication network available to the plurality of subscribers.

20. The non-transitory computer-readable storage medium of claim 16 wherein:
the UE-AMBR includes uplink UE-AMBR and downlink UE-AMBR;
the PDU-AMBR includes uplink PDU-AMBR and downlink PDU-AMBR; and
the SMBR includes uplink SMBR and downlink SMBR.
